(19) United States
(12) Patent Application Publication
(10) Pub. No.: US 2009/0259358 A1
(43) Pub. Date: Oct. 15, 2009

(54) Automotive DTC live data diagnostics

(75) Inventor: Keith Andreasen, Garden Grove, CA (US)

Correspondence Address: Neil John Graham, 6017 Lido Lane, Long Beach, CA, 90803, US

(73) Assignee: Innova Electronics Corp

(21) Appl. No.: 12/082,581

(22) Filed: Apr. 14, 2008

(51) Int. Cl. G01M 17/00

(52) U.S. Cl. 701/33

(57) ABSTRACT

It is the object of this invention to provide a system and method in the form of a program called automotive DTC live data diagnostics for analyzing live data, in real time, wherein received and analyzed diagnostic trouble codes (DTCs) are programmed to open the live data mode, selecting only the live data related to the tests used to determine the DTCs and loads and displays all the PIDs, flagging the abnormal PIDs. The invention eliminates the necessity of manually scanning through possibly several hundred PIDs in order to determine the abnormal PIDS.

### FIELD OF THE INVENTION

This invention relates generally to a system and method for monitoring certain automobile operating parameters for diagnosing operational errors and, more specifically, to an automotive live data, in real time, analyzer program within a handheld code/reader scanner that selects, orders and loads specific live data, in real time, parameters (PIDs), wherein the code reader/scanner has received and analyzed diagnostic trouble codes (DTCs) and the program opens the live data mode, selects only the live data related to the tests used to determine the DTCs, orders the selected live data tests, loads all the PIDs, flags the abnormal PIDs and displays the results.

### BACKGROUND

1. Description of Related Art

An On-Board Diagnostic, or OBD, system is a computer-based system that was developed by automobile manufacturers to monitor the performance of various components on an automobile's engine, including emission controls. Modern vehicles typically have a vehicle diagnostic system, including one or more separate computer control modules. Examples of such computer control modules (also known as just “modules”) are: a power train control module (PCM), an engine control module (ECM), a transmission control module (TCM), an ABS control module, and an air bag control module. Upon detection of any malfunction, the OBD system provides the owner of the automobile with an early warning (in other words, check engine light in the dashboard of automobile). OBD was primarily introduced to meet EPA emission standards but, through the years, onboard diagnostic systems have become more sophisticated. For example, OBD 2, Standard Edition in the mid-90s implemented in light-duty cars and trucks, provides a plurality of sensors to monitor malfunctions with engine, chassis, body, and accessory devices. In a simple scenario, the OBD system detects a malfunction in the engine (or any other component that is monitored by sensors of the OBD system) and signals a warning indicative of such a function. For example, a “check engine” light could be illuminated in an automobile's dashboard indicative of such a malfunction. The automobile's owner, upon noticing such a warning indicator, makes plans for taking the automobile to a service station where the malfunction can further be investigated. Upon arrival at the service station, repair personnel connect a cable that serves as a communications link between the automobile's diagnostic port and a computing device {such as laptop). Next, the computing device decodes OBD 2 system signals (such a diagnostic trouble codes (DTC) received via the diagnostic port) and presents them to the service station personnel who then makes a decision how to fix the malfunction.

Most portable code reader/scan tools have been code readers which only scanned and displayed the problem diagnostic codes. More expensive scan tools would have to be used to perform live tests upon the automotive system. The more recent handheld test devices have added circuits for testing systems such the charging system and scanning circuitry wherein live data can be requested for and received.

2. Description of Related Art

Modern vehicles typically have a vehicle diagnostic system, including one or more separate computer control modules. Examples of such computer control modules are: a power train control module (PCM), an engine control module (ECM), a transmission control module (TCM), an ABS control module and an air bag control module. “Off-board devices,” such as scan tools and code readers, are known in the art. Scan tool and code reader testing devices that interface with vehicle diagnostic systems access, display, and/or print vehicle diagnostic information. OBD II (On-Board Diagnostics version II) Scan Tools are one commonly known type of scan tool and are governed by a number of standards, e.g., SAE J1978 Rev. 1998-02 and SAE J1979 Rev. 1997-09. Scan tools are relatively expensive diagnostic devices that have a relatively large number of features and are typically marketed to professional automobile mechanics and service stations. Scan tools have been generally considered to be beyond the means of most automobile hobbyists and the ordinary individual interested in performing simple maintenance or service of a few vehicles, such as a family “fleet” of vehicles. There are different types of scan tools. An “OBD II Scan 45 Tool” complies with the above-identified specifications. By contrast, a “Manufacturer-Specific Scan Tool” is a scan tool that accesses and displays proprietary manufacturer-specific data (and possibly also additionally accesses and displays OBD II data). Examples include Device Controls on General so Motors, On-Demand Tests in Ford, Actuator Tests, Sensor Tests, Interrogator, and Read Temporary Codes in Chrysler. In general, air bag data, ABS data, cruise control data, and climate control data are also considered to be proprietary manufacturer-specific data and are typically included only in Manufacturer-Specific Scan Tools.

An “off-board device” that is a low-cost alternative to the scan tool is a “code reader”. In contrast with a scan tool, a code reader is a relatively basic “off-board device” that links with one or more computer modules in a vehicle diagnostic system via a vehicle computer network, reads any diagnostic trouble codes (also referred to as just “diagnostic codes” herein) asserted by those vehicle diagnostic systems, and displays any diagnostic codes on a display. Typical code readers do not perform the following major functions that are performed by typical scan tools: “View Data,” also known as “Live Data,” “Data,” and “Data Test, DTC” (viewing and displaying in real-time live, changing data from a plurality of module sensors), display of textual diagnosis descriptions corresponding to the various diagnostic codes, recording and playback of data, device control (manually controlling modules for diagnostic purposes), and reading and displaying vehicle information from the vehicle's computer (e.g., VIN information, controller calibration identification number, etc.). This information includes values (volts, rpm, temperature, speed etc.) and system status information (open loop, closed, fuel system status, etc.) generated by the vehicle sensors, switches and actuators. (Digital Can OBD2 Scan Tool Manual p. 40). Currently, companies such as Innova Electronics Corporation have combined the scan tool and code reader into a single hand held device, the Enhanced OBD2 Scan Tool. The Enhanced OBD2 Scan Tool by Innova Corp. is typical of scan tools wherein only the problem diagnostic trouble codes (DTCs) are displayed. In contrast, all the scanned live data are displayed, not just the troubled ones, this can amount to several hundred readings. The user is forced to scan through all the readings in order to retrieve the problem readings.

### SUMMARY OF THE INVENTION

It is the object of this invention to provide a system and method in the form of a program called automotive DTC live data diagnostics for analyzing live (in real-time) data wherein received and analyzed diagnostic trouble codes (DTCs) are programmed to open the live data mode, selecting only the live data related to the tests used to determine the DTCs and loads and displays all the PIDs, flagging the abnormal PIDs. The invention eliminates the necessity of manually scanning through possibly several hundred PIDs in order to determine the abnormal PIDS.

### BRIEF DESCRIPTION OF THE DRAWINGS

FIG. 1 is an illustration showing how the portable code reader/scanner interfaces to the automobile; and

FIG. 2 is a flow diagram illustrating the various ways of using the live (in real-time) data analysis program.

### DETAILED DESCRIPTION OF THE INVENTION

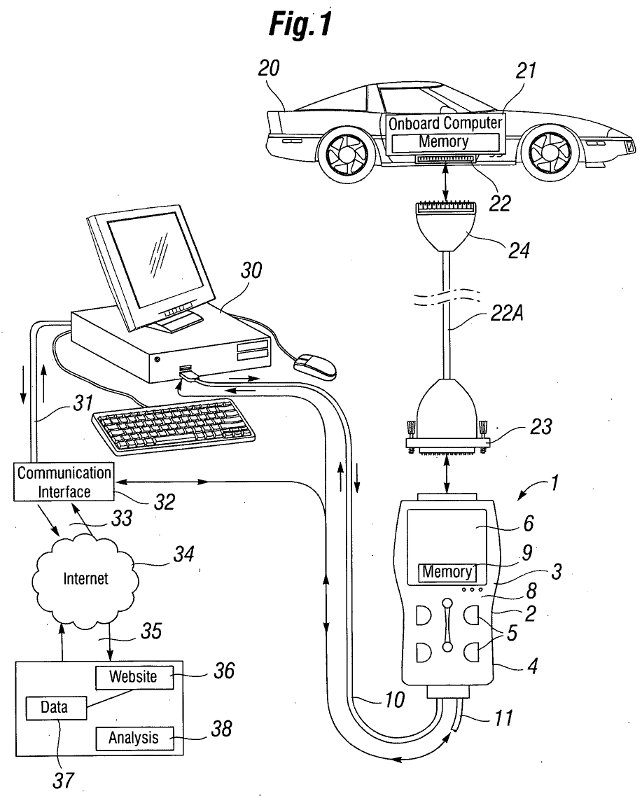

Referring to FIG. 1, the portable code reader/scanner 1 is comprised of a housing 2 enclosing a hollow interior 3. The exterior 4 of the housing 2 is comprised of a keypad 5 and a display 6 and a 16-pin connector 7 at one end. The interior 3 of the portable code reader/scanner is comprised of a processor 8 and memory 9 containing information concerning the vehicle. There also may be a cable connection 10 or a wireless blue tooth 11 to a personal desktop or laptop computer 30. The handheld connector 7 interfaces with an automobile 20 onboard computer 21 usually with an intervening vehicle interface cable connector 22a with a handheld portable testing device fitting 23 and a car fitting 24. The personal computer may have a connection 31 to a communication interface 32 which in turn may be connected 33 with the internet 34. The portable code reader/scanner 1 may then be connected 35 to a remote website 36 containing data 37 and is capable of analysis 38 of the data.

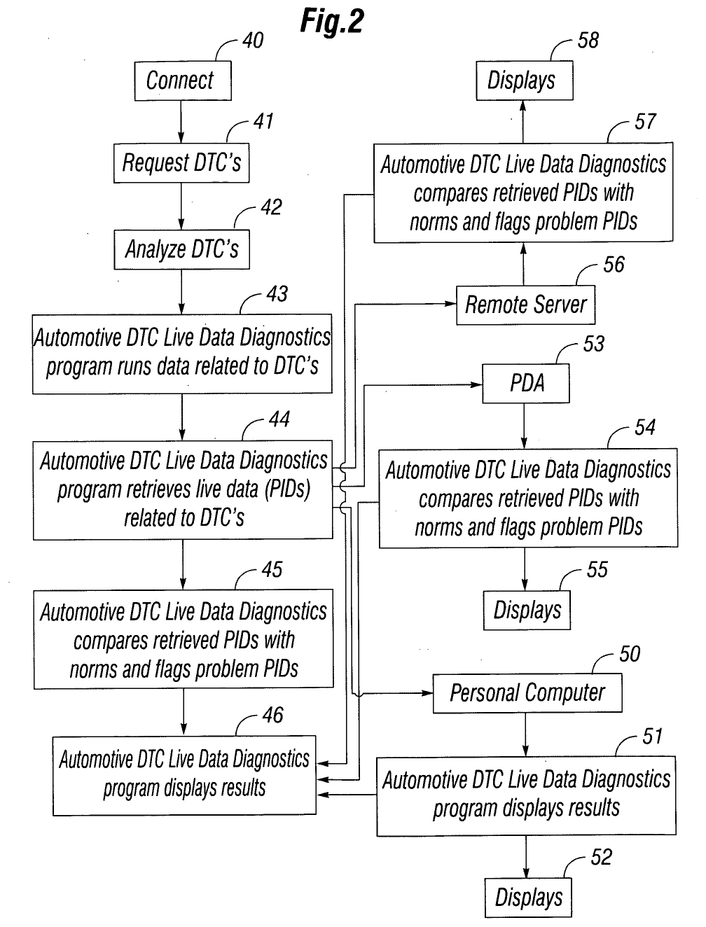

In a preferred embodiment, referring to FIG. 2, the portable code reader/scanner 1 is connected to 40 the automobile 20 on-board computer 21. At this point the diagnostic trouble codes, DTCs, may be requested 41 in order to determine problem areas. The DTCs are then analyzed 42. The portable code reader/scanner 1 is placed in the request live data mode 41 and the automotive DTC live data diagnostics program proceeds to analyze and send commands to the on-board computer 22 requesting specific live data in real-time that were used to generate the DTCs 44. The live data is in the form of PIDs and related tests. The automotive DTC live data diagnostics program then compares the retrieved PIDs with the ranges of normalcy (norms) within the database and flags the problem PIDs 45. The results are then displayed 46.

In another embodiment, referring to FIGS. 1, 2 the portable code reader/scanner 1 is connected to 40 the automobile 20 on-board computer 21. At this point the diagnostic trouble codes, DTCs, may be requested 41 in order to determine problem areas. The DTCs are then analyzed 42. The portable code reader/scanner 1 is placed in the request live data mode 41 and the automotive DTC live data diagnostics program proceeds to analyze and send commands to the on-board computer 22 requesting specific live data in real time that was used to generate the DTCs 44. The results are sent to 50 a personal computer 30 which contains the same database information concerning the vehicle automotive DTC live data diagnostics program as the portable code reader/scanner. The personal computer 30 uses the automotive DTC live data diagnostics program and compares the retrieved PIDs within ranges of normalcy (norms) and flags the problem PIDs 51. The personal computer 30 may display the PIDs 52 and/or return them to the portable code reader/scanner 1 for display 46.

In another embodiment, referring to FIGS. 1, 2 the portable code reader/scanner 1 is connected to 40 the automobile 20 on-board computer 21. At this point the diagnostic trouble codes, DTCs, may be requested 41 in order to determine problem areas. The DTCs are then analyzed 42. The portable code reader/scanner 1 is placed in the request live data mode 41 and the automotive DTC live data diagnostics program proceeds to analyze and send commands to the on-board computer 22 requesting specific live data in real time that was used to generate the DTCs 44. The results are sent to a PDA 53 which contains the same database information concerning the automotive DTC live data diagnostics program as the portable code reader/scanner. The PDA uses the automotive DTC live data diagnostics program and compares the retrieved PIDs within ranges of normalcy (norms) and flags the problem PIDs 55. The PDA 30 may display the PIDs 55 and/or return them to the portable code reader/scanner 1 for display 46.

In another embodiment, referring to FIGS. 1 and 2, the handheld portable testing device 1 is connected to 40 the automobile 20 on-board computer 21. At this point the data trouble codes, DTCs, may be requested 41 in order to determine problem areas. The DTCs are then analyzed 42. The portable code reader/scanner 1 is placed in the request live data mode 41 and the automotive DTC live data diagnostics program proceeds to analyze and send commands to the on-board computer 22 requesting specific live data in real time that was used to generate the DTCs 44. The results are sent to a remote server 56 which contains the same database information concerning the vehicle selective live data retrieval program as the portable code reader/scanner. The remote server 56 uses the automotive DTC live data diagnostics program and compares 57 the retrieved PIDs within ranges of normalcy (norms) 37 and flags 38 the problem PIDs 51. The PDA may display the PIDs 58 and/or return them to the portable code reader/scanner 1 for display 46.

An example of the programming necessary to load only the PIDs related to a DTC, the internal DBs would be configured in the following manner: (1) trouble codes are grouped into Diagnostic Monitor ((test) groups, for example, P0100, P0101 etc. are part of Continuous Component Monitor (CCM); (2) trouble codes and their monitors are grouped into the appropriate Non-Continuous Monitor test groups; and (3) trouble codes, their monitors and non-continuous test are attached the live data (PIDs) that the non-continuous tests look at to determine failure.

The above programming example was only presented as one method of programming. There are other ways the programming may be accomplished. The programming used for the invention is better described more broadly as programming means which is well known in the art.

The invention is described with specific embodiments. However, the intent of the invention is to provide a program that will analyze live data obtained from an on-board computer by comparing the retrieved data with the respective known ranges of normalcy (norms) and selecting only those retrieved values that deviate from the known ranges of normalcy (norms).

What is claimed is:

1. A portable code reader/scanner for interfacing with a vehicle's computer via a vehicle data link connector comprising:
a housing with a hollow interior and an exterior comprising a keypad and a display screen;
a connector on the exterior of the housing configured to connect to the vehicle's data link connector;
a processor containing a database and a diagnostic system within the interior of the housing;
vehicle interface circuitry configured to communicate, via a diagnostic cable, with the vehicle's computer;
a data trouble code (DTCs) reading programming within the processor which reads and retrieves diagnostic trouble codes (DTCs) from the vehicle;
a DTC database and analysis program within the processor which contains DTC codes and analysis for each type of vehicle;
a live data database within the processor which contains live data known ranges of normalcy (norms) for each type of vehicle;
test circuitry programmed to open a live data mode with the vehicle diagnostic system and retrieve live data; and
an automotive DTC live data diagnostics program which determines the live data associated with retrieved DTCs and retrieves only live data parameters (PIDs), and their related tests, that are associated with the retrieved DTCs.

2. A portable code reader/scanner according to claim 1 wherein the automotive DTC live data diagnostics program compares live data parameters (PIDs) related to the known ranges of normalcy (norms) in the database and flags the deviant PIDs.

3. A portable code reader/scanner according to claim 1 wherein the portable code reader/scanner has an external connection means such as a USB connection or Blue Tooth connection.

4. A portable code reader/scanner according to claim 3 wherein the portable code reader/scanner has a connection with external devices such as a personal computer, PDA or a remote server.

5. A portable code reader/scanner according to claim 4 wherein the portable code reader/scanner has a computer connection interfaced for connection, hardwired or wirelessly, to external devices such as a personal computer, PDA or a remote server which are programmed to receive information from and send information to the portable code reader/scanner.

6. A portable code reader/scanner according to claim 5 wherein the personal computer receives the DTCs, live data PIDs and tests relating to the PIDs from the portable code reader/scanner and uses a database and diagnostic means as found in the portable code reader/scanner and the automotive DTC live data diagnostics program to determine the live data associated with retrieved DTCs and retrieves only live data parameters (PIDs), and their related tests, that are associated with the retrieved DTCs and flags the PIDs that deviate from their known ranges of normalcy (norms).

7. A portable code reader/scanner according to claim 5 wherein the PDA receives the DTCs, live data PIDs and tests relating to the PIDs from the portable code reader/scanner and uses a database and diagnostic means as found in the portable code reader/scanner and the automotive DTC live data diagnostics program to determine the live data associated with retrieved DTCs and retrieves only live data parameters (PIDs), and their related tests, that are associated with the retrieved DTCs and flags the PIDs that deviate from their known ranges of normalcy (norms).

8. A portable code reader/scanner according to claim 5 wherein the remote server receives the DTCs, live data PIDs and tests relating to the PIDs from the portable code reader/scanner and uses a database and diagnostic means as found in the portable code reader/scanner and the automotive. DTC live data diagnostics program to determine the live data associated with retrieved DTCs and retrieves only live data parameters (PIDs), and their related tests, that are associated with the retrieved DTCs and flags the PIDs that deviate from their known ranges of normalcy (norms).

9. A portable code reader/scanner for interfacing with a vehicle's computer via a vehicle data link connector comprising:
a housing with a hollow interior and an exterior comprising a keypad and a display screen;
a connector on the exterior of the housing configured to connect to the vehicle's data link connector;
a processor containing a database and a diagnostic system within the interior of the housing;
vehicle interface circuitry configured to communicate, via a diagnostic cable, with the vehicle which contains a computer with a diagnostic system;
code reading programming within the processor which reads and retrieves data trouble codes (DTCs) from the vehicle;
programming within the processor which analyzes the retrieves diagnostic trouble codes (DTCs);
component characteristic data comprised of known good values, known ranges of normalcy (norms) for the vehicle's components stored within the database;
an automotive DTC live data diagnostics program which opens a live data mode with the vehicle diagnostic system to load only live data parameters (PIDs) related to the retrieved DTCs; and
the automotive DTC live data diagnostics program which further compares live data parameters (PIDs) related to the known ranges of normalcy (norms) in the database and flags the deviant PIDs.

10. A portable code reader/scanner according to claim 9 wherein the portable code reader/scanner has a computer connection interfaced for connection, hardwired or wirelessly, to external devices such as a laptop computer, desktop computer, PDA or a remote server.

11. A portable code reader/scanner according to claim 10 wherein the external computer, PDA or remote server have programming which compares the retrieved live data parameters (PIDs) related to the known ranges of normalcy (norms) in their databases and flags the deviant PIDs.

12. The method of a portable code reader/scanner device retrieving, with the use of a selective live data retrieval program, only automotive diagnostic real time live data that relates to received diagnostic trouble codes (DTCs) comprising:
connecting the portable code reader/scanner a to a vehicle's data link connector;
communicating to the vehicle/s computer;
receiving diagnostic trouble codes (DTCs) from the vehicle/s computer;
selecting live data mode; and
retrieving, with the use of the selective live data retrieval program, the live data parameters (PIDs) and tests that are related to the DTCs.

13. The method of retrieving and displaying automotive diagnostic live data, real time, as in claim 12 further comprising the selective data retrieval program comparing the retrieved PIDs with their known ranges of normalcy (norms) and flagging the deviant PIDs.

14. The method of retrieving and displaying automotive diagnostic real time live data as in claim 12 further comprising sending the live diagnostic parameters to a remote device such as a personal computer, PDA or a remote server.

15. The method of retrieving and displaying automotive diagnostic live data, in real time, as in claim 14 wherein the personal computer, containing a database relating to the vehicle, receives the retrieved PIDS and uses the selective data retrieval program and stored PID known ranges of normalcy (norms) for flagging the deviant PIDs.

16. The method in claim 14 wherein the personal computer shares the flagged deviant PIDs by sending them to the portable code reader/scanner.

17. The method of retrieving and displaying automotive diagnostic real time live data as in claim 14 wherein the PDA, containing a database relating to the vehicle, receives the retrieved PIDS and uses the selective data retrieval program and stored PID norms for flagging the deviant PIDs.

18. The method in claim 15 wherein the PDA shares the flagged deviant PIDs by sending them to the portable code reader/scanner.

19. The method of retrieving and displaying automotive diagnostic real time live data as in claim 14 wherein the remote server, containing a database relating to the vehicle, receives the retrieved PIDS and uses the selective data retrieval program and stored PID known ranges of normalcy (norms) for flagging the deviant PIDs.

20. The method in claim 19 wherein the remote server shares the flagged deviant PIDs by sending them to the portable code reader/scanner.
